(19) United States
(12) Patent Application Publication
(10) Pub. No.: US 2011/0310177 A1
(43) Pub. Date: Dec. 22, 2011

(54) LIQUID EJECTION DEVICE

(75) Inventor: Norihiro MASUDA, Matsumoto (JP)

(73) Assignee: SEIKO EPSON CORPORATION, Tokyo (JP)

(21) Appl. No.: 13/154,957

(22) Filed: Jun. 7, 2011

(30) Foreign Application Priority Data
Jun. 16, 2010 (JP) 2010-137353

(51) Int. Cl. B41J 23/14

(52) U.S. Cl. 347/38

(57) ABSTRACT

A liquid ejection device includes a liquid ejection head in which a nozzle is provided for ejecting a liquid to a medium conveyed in a conveyance direction, and a rotating body disposed so as to be aligned with the liquid ejection head in the conveyance direction. The rotating body rotates so that a portion of the rotating body that faces toward an upstream side in the conveyance direction moves in a direction away from a conveyance path of the medium, whereby a flow direction of an air flow that occurs in conjunction with conveyance of the medium is changed.

### CROSS-REFERENCE TO RELATED APPLICATIONS

This application claims priority to Japanese Patent Application No. 2010-137353 filed on Jun. 16, 2010. The entire disclosure of Japanese Patent Application No. 2010-137353 is hereby incorporated herein by reference.

### BACKGROUND

1. Technical Field

The present invention relates to a liquid ejection device.

2. Related Art

Inkjet printers are widely known as liquid ejection devices for ejecting a liquid to a medium. Such printers include printers which perform recording by ejecting ink (liquid) to a conveyed paper (medium) from nozzles provided to a liquid ejection head (see Japanese Laid-Open Patent Publication No. 2009-220499, for example).

In the printer described in Japanese Laid-Open Patent Publication No. 2009-220499, suction is performed near the nozzles to recover mist that occurs when the ink is ejected.

### SUMMARY

In such a printer, a flow of air occurs near the paper surface as the paper is conveyed, and an air flow thereby occurs along the conveyance direction of the paper. The mist that occurs during ink ejection, or paper dust and other airborne matter is swept along by the air flow and sometimes causes contamination by adhering to liquid ejection heads and other components positioned on the downstream side in particular.

As one method for suppressing such contamination, the airborne matter may be recovered by air suction in the vicinity of the nozzles, as described in Japanese Laid-Open Patent Publication No. 2009-220499. However, when suction is performed near the nozzles, there is a risk of disrupting the flight direction of ink droplets toward the paper surface and reducing the recording quality.

The present invention was developed in view of the problems described above, and an object of the present invention is to provide a liquid ejection device whereby adhesion of airborne matter included in an air flow inside the device can be suppressed without reducing the recording quality.

In order to achieve the objects described above, the liquid ejection device of the present invention comprises a liquid ejection head in which a nozzle is provided for ejecting a liquid to a medium conveyed in a conveyance direction; and a rotating body disposed so as to be aligned with the liquid ejection head and the conveyance direction; wherein the rotating body rotates so that a portion of the rotating body that faces toward an upstream side in the conveyance direction faces in a direction away from a conveyance path of the medium, whereby a flow direction of an air flow that occurs in conjunction with the medium being conveyed is changed.

Through this configuration, the flow direction of an air flow that occurs in conjunction with conveyance of the medium can be changed to a direction away from the conveyance path of the medium by the rotation of the rotating body. Airborne matter included with the air flow can thereby be discharged to the outside of the device. The rotating body is disposed so as to be aligned with the liquid ejection head and the conveyance direction, but because there is no suction of air near the nozzle, the flight direction of the liquid ejected from the nozzle is not disrupted. Consequently, adhesion of airborne matter included in the air flow inside the device can be suppressed without reducing the recording quality.

The liquid ejection device of the present invention further comprises a suction mechanism for suctioning air, wherein the suction mechanism has an intake port disposed in a position further away from the nozzle than the rotating body.

Through this configuration, the airborne matter included in the air flow can be recovered by the suction mechanism. Since the intake port of the suction mechanism is disposed in a position further away from the nozzle than the rotating body, suction is not performed near the nozzle, and the flight direction of the liquid ejected from the nozzle is not disrupted.

In the liquid ejection device of the present invention, the rotating body is disposed on an upstream side of the liquid ejection head in the conveyance direction, and a separating member is further provided for separating an air flow from the rotating body, the air flow occurring in conjunction with rotation of the rotating body.

Through this configuration, the air flow that occurs in conjunction with rotation of the rotating body merges with an air flow that is placed outside the conveyance path by the rotating body, and thereby includes airborne matter, but this air flow can be separated from the rotating body by the separating member. The separating member thus changes the flow direction of the air flow, thereby making it possible to suppress the airborne matter included in the air flow from adhering to the liquid ejection head positioned downstream from the rotating body.

The liquid ejection device of the present invention comprises a plurality of the liquid ejection heads disposed at an interval in the conveyance direction, and the rotating body is disposed between two the liquid ejection heads disposed side-by-side in the conveyance direction, so as to be closer to the liquid ejection head positioned on a downstream side than the liquid ejection head positioned on an upstream side.

Through this configuration, a mist created from the liquid ejection head on the upstream side among the two liquid ejection heads aligned in the conveyance direction can be suppressed from adhering to the liquid ejection head on the downstream side. By placing the rotating body near the liquid ejection head on the downstream side, adhesion of airborne matter to the liquid ejection head on the downstream side can also be more reliably suppressed in a case in which an air flow is disrupted by the effects of a surrounding wall surface or the like, for example.

In the liquid ejection device of the present invention, the rotating body is a rotating roller that rotates about a rotational axis extending in a width direction intersecting with the conveyance direction, and the rotating roller has a peripheral surface extending in the width direction.

Through this configuration, when a rotating brush having a nap, for example, is rotated, the mist adhering to the nap is collected into droplets on the distal end side by centrifugal force, and there is a risk of the droplets scattering on the periphery, but by making the rotating body a rotating roller, the scattering of liquid can be suppressed. Since the rotating roller also can recover the adhering airborne matter by wiping off the peripheral surface, operation and maintenance are facilitated.

### BRIEF DESCRIPTION OF THE DRAWINGS

Referring now to the attached drawings which form a part of this original disclosure:

FIG. 1 is a front view showing the overall structure of the printer according to a first embodiment; and

FIG. 2 is a front view showing the overall structure of a printer according to a second embodiment.

### DETAILED DESCRIPTION OF EXEMPLARY EMBODIMENTS

### First Embodiment

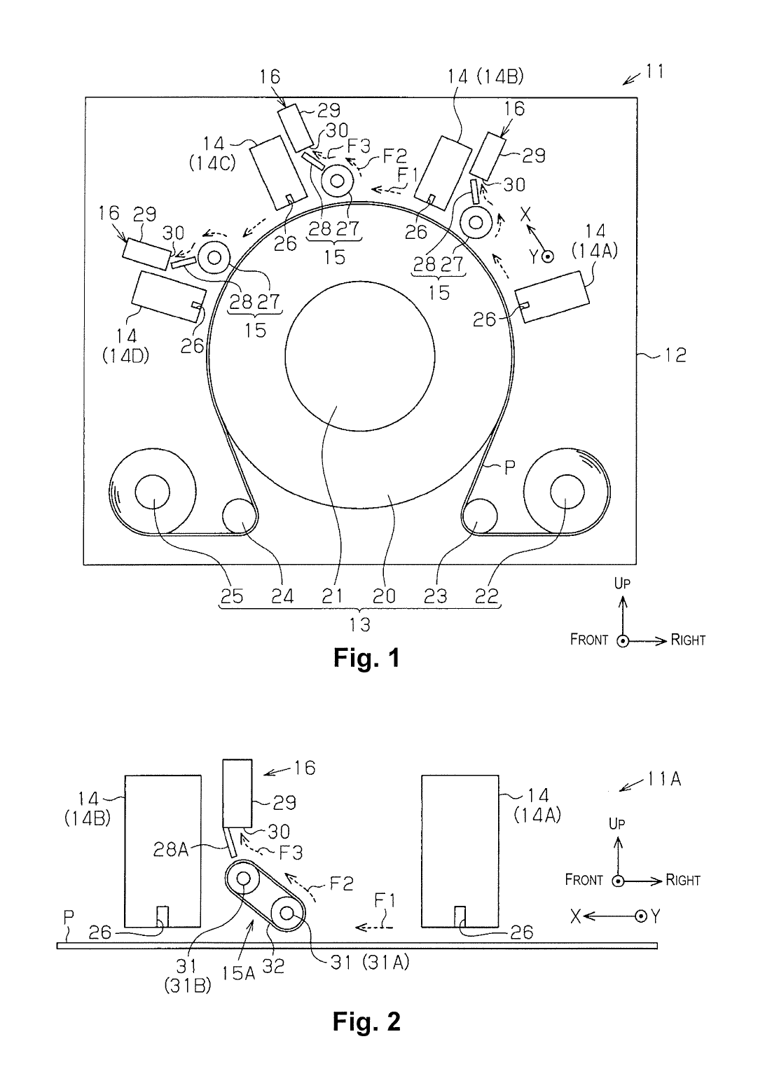

A first embodiment in which the present invention is applied to an inkjet printer (referred to simply as “printer” hereinafter) as a type of liquid ejection device will first be described based on FIG. 1. The “front-rear direction,” “left-right direction,” and “vertical direction” referred to in the following description are based on the directions indicated by arrows in the drawings.

The printer 11 shown in FIG. 1 is provided with a support plate 12, a conveyance mechanism 13, liquid ejection heads 14 (14A, 14B, 14C, 14D), air flow control mechanisms 15, and suction mechanisms 16. The conveyance mechanism 13 is provided with a support member 20, a rotating shaft 21, a paper feed roller 22, a first roller 23, a second roller 24, and a winding roller 25.

The rotating shaft 21 is supported in cantilever fashion by the support plate 12 on one side (rear side) in the width direction Y of a paper P orthogonal to the conveyance direction X, and rotates in conjunction with the driving of a conveyance motor not shown in the drawing. The support member 20 has a cylindrical shape whose axis extends in the width direction Y (front-rear direction), and is supported so as to be able to rotate integrally with the rotating shaft 21.

The paper P as a medium is an elongated paper which is wound up by the winding roller 25 after being unwound from the paper feed roller 22 and wound onto the first roller 23, the support member 20, and the second roller 24. The paper P is conveyed in the conveyance direction X in conjunction with the rotation of the paper feed roller 22, the support member 20, and the winding roller 25.

A plurality (four in the present embodiment) of liquid ejection heads 14 is disposed at a predetermined interval in the conveyance direction X of the paper P so as to surround an external peripheral surface of the support member 20. Any number of liquid ejection heads 14 may be provided. Each liquid ejection head 14 is provided with a nozzle 26 for ejecting ink as a liquid to the paper P at a position opposite the support member 20.

In each liquid ejection head 14, a plurality of nozzles 26 is provided in the width direction Y so as to cover the entire width of the paper P, and a nozzle row for ejecting the same ink is thereby formed. In other words, the printer 11 is a line-head printer which is capable of recording (printing) through the entire width of the paper P without movement of the liquid ejection heads 14.

The ink ejected from the liquid ejection heads 14 is received by the surface side of the paper P, the back side of which is wound onto the support member 20, and recording is thereby performed. In the following description, the direction in which the liquid ejection heads 14 eject ink, i.e., the direction from the liquid ejection heads 14 to the paper P (support member 20), is referred to as the ejection direction.

The air flow control mechanisms 15 and the suction mechanisms 16 form pairs, and are disposed between each set of two liquid ejection heads 14 adjacent in the conveyance direction X, so as to be closer to the liquid ejection heads 14B, 14C, 14D positioned on the downstream side than to the liquid ejection heads 14A, 14B, 14C positioned on the upstream side, respectively. Each of the air flow control mechanisms 15 has a rotating roller 27 as a rotating body, and a plate-shaped separating member 28 which extends in the width direction Y. Each of the suction mechanisms 16 sucks a gas, and has a duct 29, an intake port 30 opening at one end of the duct 29, and a suction fan not shown in the drawing.

Each rotating roller 27 rotates about a rotational axis which extends in the width direction Y, and has a peripheral surface which extends in the width direction Y. The rotating rollers 27 are disposed in aligned positions on the upstream side of the liquid ejection heads 14B, 14C, 14D in the conveyance direction X, and the external peripheral surfaces of the rotating rollers 27 are disposed so as to approach the paper P which is wound onto the support member 20. Each rotating roller 27 rotates in the counterclockwise direction in FIG. 1 so that the portion thereof facing the upstream side in the conveyance direction X faces in the direction away from the support member 20.

The separating members 28 are supported by the support plate 12 and disposed on the upstream side of the liquid ejection heads 14B, 14C, 14D in the conveyance direction X. The separating members 28 are also disposed so that the ends thereof on the upstream side in the ejection direction are near the intake ports 30 of the suction mechanisms 16, and the other ends thereof on the downstream side in the ejection direction are disposed near the peripheral surfaces of the rotating rollers 27. In other words, the intake ports 30 of the suction mechanisms 16 are disposed in positions further away from the nozzles 26 than the rotating rollers 27.

The operation of the air flow control mechanisms 15 and the suction mechanisms 16 will next be described.

In the printer 11, an air flow F1 (conveyance air flow) in the flow direction of the conveyance direction X occurs in conjunction with conveyance of the paper P. When a mist of ink is created on the periphery of the nozzles 26 in conjunction with ejection of ink from the liquid ejection heads 14, the mist is swept along by the air flow F1 and carried downstream in the conveyance direction X.

Contamination occurs when the mist adheres to the liquid ejection heads 14 and other components positioned downstream. In particular, adhesion of mist formed from the liquid ejection heads 14A, 14B, 14C to the liquid ejection heads 14B, 14C, 14D positioned downstream, respectively, causes clogging of nozzles 26 or ink ejection problems, which can lead to reduced recording quality.

Therefore, during ink ejection in the printer 11, the rotating rollers 27 are rotated, and suction is performed by the suction mechanisms 16. An air flow F2 (rotational air flow) is then created in conjunction with the rotation of the rotating rollers 27. At this time, since the rotating rollers 27 are disposed so as to approach the conveyance path of the paper P, the flow direction of the air flow F1 changes so as to become a portion of the air flow F2.

The air flow F2 that occurs in conjunction with the rotation of the rotating rollers 27 is separated from the rotating rollers 27 by the separating members 28 and suctioned by the suction mechanisms 16 through the intake ports 30 as an air flow F3 (separation air flow). In other words, the air flow F1 that occurs in conjunction with conveyance of the paper P is controlled by the air flow control mechanisms 15 so that the flow direction thereof changes. The mist and other airborne matter included in the air flows F1 through F3 are suctioned by the suction mechanisms 16 and thereby removed from the periphery of the liquid ejection heads 14.

Such effects as those described below can be obtained through the first embodiment described above.

(1) The flow direction of the air flow F1 that occurs in conjunction with conveyance of the paper P can be changed to a direction away from the conveyance path of the paper P by the rotation of the rotating rollers 27 of the air flow control mechanisms 15. Airborne matter included with the air flow F1 can thereby be discharged to the outside of the device. The rotating rollers 27 are disposed so as to be aligned with the liquid ejection heads 14 and the conveyance direction X, but because there is no suction of air near the nozzles 26, the flight direction of the ink ejected from the nozzles 26 is not disrupted. Consequently, adhesion of airborne matter included in the air flow F1 inside the device can be suppressed without reducing the recording quality.

(2) The airborne matter included in the air flows F1 through F3 can be recovered by the suction mechanisms 16. Since the intake ports 30 of the suction mechanisms 16 are disposed in positions further away from the nozzles 26 than the rotating rollers 27, suction is not performed near the nozzles 26, and the flight direction of the ink ejected from the nozzles 26 is not disrupted.

(3) The air flow F2 that occurs in conjunction with rotation of the rotating rollers 27 merges with the air flow F1 that is placed outside the conveyance path by the rotating rollers 27, and thereby includes airborne matter, but this air flow F2 can be separated from the rotating rollers 27 by the separating members 28. The separating members 28 thus change the flow direction of the air flow F2, thereby making it possible to suppress the airborne matter included in the air flows F1, F2 from adhering to the liquid ejection heads 14 positioned downstream from the rotating rollers 27.

(4) A mist created from the liquid ejection heads 14 on the upstream side among each set of two liquid ejection heads 14 aligned in the conveyance direction X can be suppressed from adhering to the liquid ejection heads 14 on the downstream side. By placing the rotating rollers 27 near the liquid ejection heads 14 on the downstream side, adhesion of airborne matter to the liquid ejection heads 14 on the downstream side can also be more reliably suppressed in a case in which the air flow F1 is disrupted by the effects of a surrounding wall surface (support plate 12) or the like, for example.

(5) When a rotating brush having a nap, for example, is rotated, the mist adhering to the nap is collected into droplets on the distal end side by centrifugal force, and there is a risk of the droplets scattering on the periphery, but by making the rotating body a rotating roller 27, the scattering of ink can be suppressed. Since the rotating rollers 27 also can recover the adhering airborne matter by wiping off the peripheral surface, operation and maintenance are facilitated.

(6) Since the separating members 28 are disposed so that the ends thereof are near the intake ports 30 of the suction mechanisms 16, and the other ends thereof are disposed near the peripheral surfaces of the rotating rollers 27, the airborne matter included in the air flows F1 through F3 can be efficiently recovered.

### Second Embodiment

A second embodiment of the present invention will be described based on FIG. 2. The following description will focus primarily on portions that differ from the first embodiment. Constituent elements that are the same or that correspond to constituent elements in the first embodiment are referred to by the same reference symbols, and no redundant description thereof will be given.

As shown in FIG. 2, the printer 11A according to the second embodiment has a plurality of liquid ejection heads 14 (14A, 14B) having nozzles 26, the same as in the first embodiment, but differs from the first embodiment in that the paper P is conveyed along a linear conveyance path. In other words, the conveyance direction X in the present embodiment is the left direction, and the liquid ejection heads 14 are disposed in the left-right direction. The ink ejection direction of each liquid ejection head 14 is downward.

The paper P may be an elongated paper, or single sheets cut to a predetermined length. Only two liquid ejection heads 14 are shown in FIG. 2, but three or more liquid ejection heads 14 may be provided. In this case, air flow control mechanisms 15A and suction mechanisms 16 which form pairs are preferably provided between each set of two liquid ejection heads 14 adjacent in the conveyance direction X, the same as in the first embodiment.

The air flow control mechanism 15A of the present embodiment has two support rollers 31 (31A, 31B), and a rotating belt 32 as a rotating body wound onto both support rollers 31. Both support rollers 31 rotate in the counterclockwise direction in FIG. 2 about rotational axes which extend in the width direction Y. The rotating belt 32 has a peripheral surface which extends in the width direction Y, and the rotating belt 32 rotates (circularly moves) in conjunction with the rotation of the support rollers 31. The support rollers 31 have a smaller diameter than the rotating rollers 27.

Among the two support rollers 31, the support roller 31A on the upstream side in the conveyance direction X is disposed lower (toward the conveyance path) than the support roller 31B on the downstream side so as to approach the paper P. The rotating belt 32 rotates in the counterclockwise direction in FIG. 2 so that the portion thereof facing upstream in the conveyance direction X faces the direction away from the conveyance path of the paper P. A separating member 28A is disposed so that the upper end thereof is supported by the suction mechanism 16, and the lower end thereof is positioned so as to approach the support roller 31B via the rotating belt 32.

When the rotating belt 32 is rotated during ink ejection, an air flow F2 occurs in conjunction with the rotation of the rotating belt 32. The flow direction of an air flow F1 is then changed so that the air flow F1 becomes a portion of the air flow F2. The air flow F2 is separated from the rotating belt 32 by the separating member 28A. When suction by the suction mechanism 16 is performed in accordance with the rotation of the rotating belt 32, an air flow F3 separated from the rotating belt 32 is suctioned by the suction mechanism 16 through the intake port 30.

In other words, the air flow F1 that occurs in conjunction with conveyance of the paper P is controlled by the air flow control mechanism 15A so that the flow direction thereof changes. The mist and other airborne matter included in the air flows F1 through F3 are suctioned by the suction mechanism 16 and thereby removed from the periphery of the liquid ejection heads 14.

Through the second embodiment described above, the effects described below can be obtained in addition to the same effects as described in (1) through (5) above.

(7) By rotating a rotating belt 32 wound onto support rollers 31 having a smaller diameter than the rotating rollers 27, the resistance to the air flow F1 can be reduced, and the flow direction can be changed without disrupting the flow.

(8) Since the separating member 28A is supported by the suction mechanism 16, the air flow F3 which includes the airborne matter can be suctioned from the intake port 30 without leakage.

The embodiments described above may be modified as described below.

The air flow control mechanism 15A may be provided to the printer 11 of the first embodiment, or the air flow control mechanism 15 may be provided to the printer 11A of the second embodiment. Alternatively, air flow control mechanisms 15, 15A may be provided to a single printer.

A configuration may be adopted in which a rotating belt or a rotating roller having an internal cavity is employed, ventilation holes are formed on the peripheral surface thereof, and the internal cavity functions as a duct of a suction mechanism 16. In this case, airborne matter can be efficiently suctioned in a small installation space. Since the separating member 28 may also be omitted, the configuration can be simplified.

A configuration may be adopted in which a suction mechanism 16 is not provided. In this case as well, by providing the separating member 28 or the rotating belt 32 so that the end thereof on the upstream side in the ejection direction extends to the outside of the device, an air flow which includes airborne matter can be discharged to the outside of the device, and adhesion of airborne matter inside the device can be suppressed. The “outside of the device” referred to herein may be outside of a main body case of the printer, or outside of a printing chamber formed by wall surfaces for surrounding the liquid ejection heads 14.

A configuration may be adopted in which a separating member 28 is not provided. In this case as well, the airborne matter included in the air flow F2 can be suctioned by disposing the intake port 30 of the suction mechanism 16 so as to be opposite the flow direction of the air flow F2.

An air flow control mechanism 15, 15A (and a suction mechanism 16) may be provided also on the upstream side of the liquid ejection head 14A that is disposed furthest upstream in the conveyance direction X. Through this configuration, adhesion of paper dust and the like to the liquid ejection head 14A can be suppressed.

An air flow control mechanism 15, 15A (and a suction mechanism 16) may be provided also on the downstream side of the liquid ejection head 14 that is disposed furthest downstream in the conveyance direction X. Through this configuration, contamination of wall surfaces or the like positioned on the downstream side of the liquid ejection heads 14 can be suppressed, and airborne matter diffused by an air flow colliding with the wall surface can be suppressed from adhering to the liquid ejection heads 14.

A configuration may be adopted in which a single liquid ejection head 14 is provided. In this case, adhesion of paper dust and the like to the liquid ejection head 14 can be suppressed by disposing an air flow control mechanism 15, 15A (and a suction mechanism 16) on the upstream side of the liquid ejection head 14 in the conveyance direction X. Contamination of the inside of the device by mist that occurs from the liquid ejection head 14 can be suppressed by disposing an air flow control mechanism 15 (and a suction mechanism 16) on the downstream side of the liquid ejection head 14.

In such cases as when the interval between liquid ejection heads 14 adjacent in the conveyance direction X is short, the air flow control mechanisms 15, 15A (and suction mechanisms 16) may be provided at any position between two liquid ejection heads 14. A formed mist can be suppressed form diffusing to the periphery by disposing the air flow control mechanisms 15, 15A (and suction mechanisms 16) near the liquid ejection heads 14 that are positioned on the upstream side among adjacent liquid ejection heads 14 in the conveyance direction X.

The medium is not limited to paper, and may be changed to a plastic film or seal, a metal foil, a plate, a cloth, or a medium of any other material or shape which is capable of receiving a liquid.

The printer is not limited to a line-head printer. For example, the printer may be a serial printer provided with a carriage for moving reciprocally along a scanning direction which intersects the conveyance direction of the medium, and a liquid ejection head which is supported by the carriage. In a serial printer, the air flow control means is preferably provided with a rotating roller (or rotating belt supported by a support roller which rotates about the rotational axis) which rotates about a rotational axis which extends in the scanning direction of the carriage.

The liquid ejection device is applied to an inkjet printer in the embodiments described above, but the present invention may be applied to a liquid ejection device for ejecting or discharging a liquid other than ink, and may also be applied to various types of liquid ejection devices which are provided with a liquid ejection head or the like for discharging minute droplets. The term “droplet” refers to the state of the liquid discharged from the liquid ejection device, and includes droplets which leave granular, teardrop-shaped, or filament-shaped traces. The liquid referred to herein may be any liquid composed of a material which can be ejected by the liquid ejection device. For example, the liquid is preferably in a state in which the material thereof is in the liquid phase, and includes not only fluids and materials that are liquid in one state thereof, such as high or low-viscosity liquids, sol/gel solutions, and other inorganic solvents, organic solvents, solutions, liquid resins, and liquid metals (metal liquids), but liquids in which particles of functional material composed of pigments, metal particles, and other solids are dissolved, dispersed, or mixed in a solvent. Ink, liquid crystal, or the like such as described in the embodiment above are cited as typical examples of the liquid. The term “ink” includes common water-based ink, oil-based ink, gel ink, hot-melt ink, and various other liquid compositions. Specific examples of the liquid ejection device may include liquid ejection devices for ejecting liquid which includes electrode material, color material, or other material in dispersed or dissolved form for use in such applications as manufacturing liquid crystal displays, EL (electroluminescent) displays, surface-emitting displays, and color filters; liquid ejection devices for ejecting biological organic materials used to manufacture biochips; liquid ejection devices used as precision pipettes for ejecting liquids as test samples; and textile printing devices, microdispensers, and the like. Liquid ejection devices for ejecting lubricating oil with pinpoint precision onto a clock, camera, or other precision machine; liquid ejection devices for ejecting UV-curing resin or other transparent resin liquids onto a substrate to form micro hemispherical lenses (optical lenses) used in an optical communication device or the like; and liquid ejection devices for ejecting acid or alkaline etching solution for etching a substrate or the like may be used.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A liquid ejection device comprising:
a liquid ejection head including a nozzle configured and arranged to eject a liquid to a medium conveyed in a conveyance direction; and
a rotating body disposed so as to be aligned with the liquid ejection head in the conveyance direction, the rotating body being configured and arranged to rotate so that a portion of the rotating body that faces toward an upstream side in the conveyance direction moves in a direction away from a conveyance path of the medium, whereby a flow direction of an air flow that occurs in conjunction with conveyance of the medium is changed.

2. The liquid ejection device according to claim 1, further comprising
a suction mechanism configured and arranged to suction air, the suction mechanism having an intake port disposed in a position further away from the nozzle than the rotating body.

3. The liquid ejection device according to claim 1, further comprising
a separating member configured and arranged to direct an air flow, which occurs in conjunction with rotation of the rotating body, away from the rotating body, the rotating body being disposed on an upstream side of the liquid ejection head in the conveyance direction.

4. The liquid ejection device according to claim 1, wherein
a plurality of the liquid ejection heads disposed at an interval in the conveyance direction,
the rotating body is disposed between two of the liquid ejection heads disposed side-by-side in the conveyance direction, so as to be closer to the liquid ejection head positioned on a downstream side than the liquid ejection head positioned on an upstream side.

5. The liquid ejection device according to claim 1, wherein
the rotating body includes a rotating roller configured and arranged to rotate about a rotational axis extending in a width direction intersecting with the conveyance direction, and the rotating roller has a peripheral surface extending in the width direction.
